(19) United States
(12) Patent Application Publication
(10) Pub. No.: US 2007/0063996 A1
(43) Pub. Date: Mar. 22, 2007

(54) Image display system and method

(76) Inventor: Winthrop D. Childers, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/226,110

(22) Filed: Sep. 14, 2005

(51) Int. Cl. G09G 5/00

(52) U.S. Cl. 345/204

(57) ABSTRACT

Disclosed are embodiments of a system and method for processing an image. An image processing unit includes a processor unit and a control unit. The processor unit is configured to analyze an incoming video signal and to select an optimized frame period in response. The control unit is configured to generate first control signal that manifests a sequence of bit plane time slices on a spatial light modulator during the optimized frame period. The control unit is further configured to generate a second control signal that defines a sequence of more than 15 primary color transitions for a solid state light source that illuminates the spatial light modulator during the optimized frame period.

### BACKGROUND

Various techniques for displaying images exist. One such approach is the DLP (digital light processing) system that utilizes a periodic sequential color source such as a color wheel modulating light from an arc lamp and a DMD (digital mirror device). Generally speaking, the periodic color source generates a sequence of primary colored sub-frames. For example, a three-segment RGB (red, green, blue) color wheel generates one color sub-frame for each of red, green, and blue during one frame period (or in some cases two color sub-frames if rotated at double speed). The color sub-frames are further modulated by the DMD pixel elements to form pixels on a viewing surface. This system has some challenges.

One challenge is the prevention of sequential-related artifacts. For example, when such a system displays a bouncing white ball on a black background, the image can actually appear to have one edge that is red and another edge that is blue. Solutions to overcoming these artifacts include increasing the number of color sub-frames by increasing the number of segments in the color wheel. This has the effect of increasing the number of color sub-frames during one frame period. This also unfortunately increases a “spoke loss” due to the inability to selectively generate primary colored bit planes that are temporally too close to the boundary between two color sub-frames.

### SUMMARY

Exemplary embodiments of the present invention include a system and method for processing an image. An image processing unit includes a processor unit and a control unit. The processor unit is configured to analyze an incoming video signal and to select an optimized frame period in response. The control unit is configured to generate a first control signal that manifests a sequence of bit plane time slices on a spatial light modulator during the optimized frame period. The control unit is further configured to generate a second control signal that defines a sequence of more than 15 primary color transitions for a solid state light source that illuminates the spatial light modulator during the optimized frame period.

### BRIEF DESCRIPTION OF THE DRAWINGS

FIG. 1 illustrates a schematic diagram of a system for displaying images according to an embodiment of the present invention.

FIG. 2 is timing diagram illustrating a portion of a frame period including a sequence of bit planes according to an embodiment of the present invention.

FIGS. 3A-3C are timing diagrams illustrating exemplary least significant bit planes according to an embodiment of the present invention.

FIGS. 4A-4C are timing diagrams illustrating exemplary least significant bit planes according to an embodiment of the present invention.

FIGS. 5A-5C are timing diagrams illustrating exemplary least significant bit planes according to an embodiment of the present invention.

FIGS. 6A-6C are exemplary time periods illustrating a data loading sequence in accordance with an embodiment of the present invention.

### DETAILED DESCRIPTION

In the following Detailed Description, reference is made to the accompanying drawings, which form a part hereof, and in which is shown by way of illustration specific embodiments in which the invention can be practiced. It is to be understood that other embodiments can be utilized and structural or logical changes can be made without departing from the scope of the present invention. The following Detailed Description, therefore, is not to be taken in a limiting sense, and the scope of the present invention is defined by the appended claims.

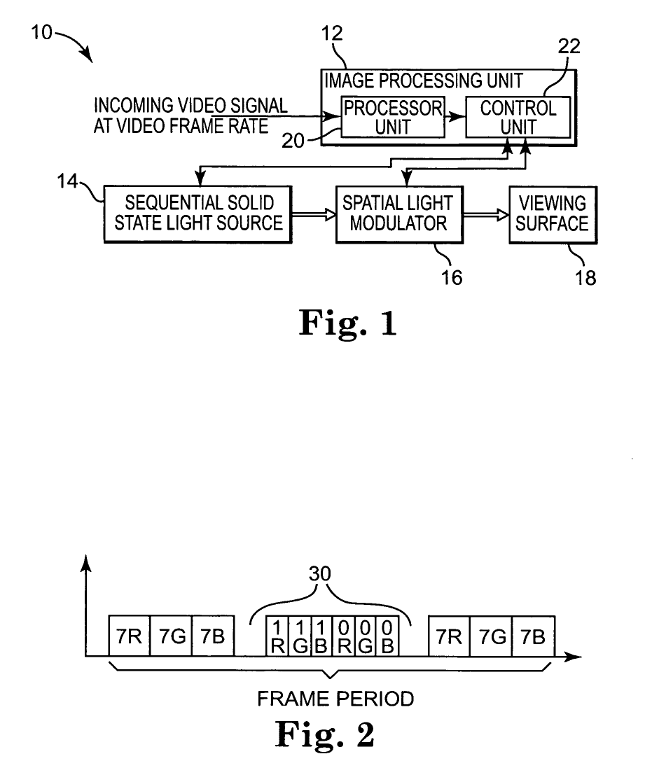

FIG. 1 illustrates image display system 10 in accordance with one embodiment of the present invention. In one example, image display system 10, includes image processing unit 12, sequential solid state light source 14, spatial light modulator 16 and viewing surface 18. In one example, image display system 10 is a digital projector that is used to project an image. Image processing unit 12 receives an incoming video signal. The video signal has an associated video frame rate. Image processing unit 12 processes the video signal and then controls the sequential solid state light source 14 and spatial light modulator 16 in order to project the incoming video signal as an image on viewing surface 18.

In one embodiment, image processing unit 12 includes processor unit 20 and control unit 22. Processor unit 20 is configured to receive the incoming video signal and to generate image characteristic information indicative of the video signal. Control unit 22 is then configured to receive the image characteristic information indicative of the video signal and to generate control signals used to control solid state light source 14 and spatial light modulator 16. In this way, rather than being optimized for high color saturation or high brightness, image display system 10 in accordance with one embodiment of the invention provides an analysis of the characteristics of the video signal in order to provide optimized image frame and/or bit plane generation according to the characteristics of the video signal.

In one embodiment, sequential solid state light source 14 is a plurality of solid state light emitting diodes (LEDs). For example, in one case, sequential solid state light source 14 includes red LED(s), green LED(s), and blue LED(s). It can be appreciated that alternative and/or additional solid state light sources can be used generating colors such as white, cyan, yellow, magenta, among others. The solid state light source is optically configured to illuminate a pixel array formed in a surface of spatial light modulator 16.

In one embodiment, spatial light modulator 16 is a digital micro-mirror device (DMD). A DMD has an array of micro-mechanical display elements, each having a tiny mirror that is individually addressable with an electronic signal. Depending on the state of its addressing signal, each mirror tilts so that it either does or does not couple light to an image plane of viewing surface 18. Each of the mirrors is referred to as a “pixel element,” and the image each pixel element generates upon the viewing surface 18 can be referred to as a “pixel.” Generally, displaying pixel data is accomplished in part by loading memory cells connected to the pixel elements. Each memory cell receives one bit of data representing an on or off state of a pixel element. The image processing unit 12 is configured to maintain the pixel elements in their on or off states for a controlled duration.

The present invention can be applicable to other spatial light modulators 16 that are rapidly switchable between on and off states to define images on a viewing surface. Examples of other spatial light modulator technologies include LCOS (liquid crystal on silicon) and linear arrays of deflectable beams.

In one embodiment, the image processing unit 12 is configured to receive an incoming video signal at the video frame rate, and to convert that signal into a sequence of image frames, each having a frame period. Each image frame defines primary color values for each pixel to be defined upon viewing surface 18. In one example, the color values would represent the intensity of red, green, and blue components of light to be displayed for each pixel displayed on viewing surface 18.

The image processing unit 12 is further configured to convert each image frame into a plurality of bit planes within the frame period. Each of the plurality of bit planes defines an associated primary color and bit plane time period having a bit plane time duration. Within a bit plane time period, each pixel element of modulator 16 is either in an on or off state. Each bit plane time period further defines one or more time slices, each having a time slice time period. When a bit plane time period is divided into more than one time slice, the time slices are temporally separated within the frame period. To define the primary color associated with the bit plane, the image processing unit 12 is configured to operate the solid state light source 14 to illuminate the spatial light modulator 16 with light having a spectral distribution that defines the primary color during the bit plane time period.

During the bit plane time period, an array of pixels corresponding to the array of pixel elements is cast upon viewing surface 18. For the array of pixels, there is a pixel having the primary color corresponding to each pixel element that is in the on state. There is a missing or black pixel for each pixel element that is in the off state.

In one embodiment, control unit 22 sends control signals to the solid state light source defining a sequence of states for the solid state light source. Each of the sequence of states defines an average intensity and a primary color of light that the solid state light source 14 provides to the array of pixel elements on spatial light modulator 16 during each bit plane time period.

In one embodiment, each of the sequence of states for the solid state light source 14 corresponds to one of the sequence of time slices that are each manifested on spatial light modulator 16, one time slice after another. During the sequence of time slices, the average intensity (averaged over the time slice time period) changes from one time slice to the next for one or more sequential pairs of time slices. During the sequence of time slices, a selection of a primary color of light that the solid state light source 14 provides changes from one time slice to the next for one or more sequential pairs of time slices. This change in the primary color of light from one time slice to the next is referred to as a primary color transition.

In one embodiment, a second control signal from image processing unit 12 defines more than 15 primary color transitions for the solid state light source 14 that illuminates the spatial light modulator 16 during a frame period. In another embodiment, the second control signal defines more than 20 primary color transitions during a frame period. In another embodiment, the second control signal defines more than 30 primary color transitions during a frame period In another embodiment, the number of primary color transitions is at least equal to the bit depth of the display system. In another embodiment the number of time slices is substantially equal to the number of primary color transitions during a frame period.

In one embodiment, the control unit 22 sends control signals to the solid state light source 14 that defines a sequence of light pulses emitted by the solid state light source 14. A light pulse is defined as the light source 14 turning on for a brief duration and then off. A light pulse is characterized by an average intensity level, a primary color emitted, and a duration of time.

In one embodiment, each light pulse has a time duration that falls within one of the time slices. Stated another way, the solid state light source 14 turns on at the beginning or within the time slice time period and turns off at the end or within the time slice period so that the duration during which the solid state light source is on (the light pulse duration) falls within the time slice time period. For some time slices, there can be more than one light pulse emitted during each time slice time period.

To quantify the generation of bit planes, consider an example wherein the image frames are generated at 60 frames per second such that each frame lasts for approximately 16.67 milliseconds. To generate 24 bit color or 8 bits per primary color, a minimum of 8 bit planes need to be defined per primary color. The bit planes typically have time durations that vary in a binary manner, from the least significant bit (“LSB”) to the most significant bit (MSB).

Based upon this, it would be expected that the LSB for a given primary color would have a time duration of about one third of about 1/256^{th} of a frame period, or about 22 microseconds. This can result in an operational bottleneck due to the immense data rate and mirror frequency requirements for the system to position the mirrors for a bit plane. In one embodiment, this can be mitigated by modulating the light source within bit planes to extend the minimum duration requirement for bit planes.

Having a time-contiguous MSB can result in visual artifacts frame to frame. Therefore, dividing up the MSB over the frame period can be optimal. Stated another way, the most significant bit time period is divided up into non-contiguous or temporally separated time slices. For each most significant bit plane, the time slices are distributed or temporally spaced apart during the frame period.

An exemplary set of bit planes for a single primary color that takes the aforementioned factors into account is depicted in the following table:

| Bit | | Duration/Time | | |
|---|---|---|---|---|
| Plane | Weighting | Slice | No. of Slices | Avg. Intensity |
| 0 | 1 | 1 | 1 | 1 |
| 1 | 2 | 1 | 1 | 2 |
| 2 | 4 | 1 | 1 | 4 |
| 3 | 8 | 1 | 1 | 8 |
| 4 | 16 | 2 | 1 | 8 |
| 5 | 32 | 2 | 2 | 8 |
| 6 | 64 | 2 | 4 | 8 |
| 7 | 128 | 2 | 8 | 8 |

In this example, the entire frame period is divided up onto 19 time slices for each of red, green, and blue, or a total of 57 time slices. The least significant bit plane is generated in one time slice that is about 163 microseconds long. This is made possible by the variation in the average intensity adjustments for bit planes 0 to 3. In the example depicted in the table above, the most significant bit plane (bit 7) time period is divided up into 8 separate time slices that can be temporally separated over the frame period.

The following defines terms used in the table.

Weighting: The weighting depicted above is binary, but this need not be the case. The weighting factor is proportional to the per pixel contribution to the average intensity during a frame period when that pixel is turned ON.

Duration/Time Slice: The time duration of each time slice. For the case where each of three primary colors are handled equally and for a 60 hertz frame rate, the shortest duration time slice (for bit planes 0-3) would have a duration of about 163 microseconds.

No. of Slices: How many time slices are required to provide that significance of bit. Stated another way, this is the number of temporally spaced time slices utilized to provide the bit plane time period.

Avg. Intensity: Average intensity of light received by the DMD from the solid state light source during each time slice for that bit. This intensity level can be achieved by varying the actual intensity of the light source or by varying the duty cycle (percentage of the duration of the bit plane for which the light source is ON) during the bit plane time period.

To avoid various visual artifacts, it is best to temporally separate the most significant bits for each primary color. Keeping this in mind, the following is an exemplary temporal sequence of time slices during a frame period based on the earlier table:

7R,7G,7B,6R,6G,6B,7R,7G,7B,4R,4G,4B,7R,7G,7B,3R,3G,3B,2R,2G,2B, 1R,1G,1B,0R,0G,0B,6R,6G,6B,7R,7G,7B,5R,5G,5B,7R,7G,7B,6R,6G,6B, 7R,7G,7B,5R,5G,5B,7R,7G,7B,6R,6G,6B 7R,7G,7B

In this example, 6R is indicative of one time slice of bit 6 for red, 3B means bit 3 for blue, etc. As discussed earlier, bits 7, 6, and 5 for each primary color are divided up into 8, 4, and 2 temporally separated time slices respectively. In this example, the number of primary color transitions during a frame period is substantially equal to the number of time slices. This eliminates the “rainbow effect”. However, this system does not trade off brightness or color saturation with this large number of transitions. In this way, the image processing unit 12 generates first control signals to define the bit planes such as those discussed above that are manifested upon spatial light modulator 16.

Again, a timing diagram illustrating part of the time slices from this sequence is depicted in FIG. 2. The timing diagram of FIG. 2 only depicts 12 of the 57 time slices in the sequence above with time slices in gaps 30 left out of the timing diagram for simplicity.

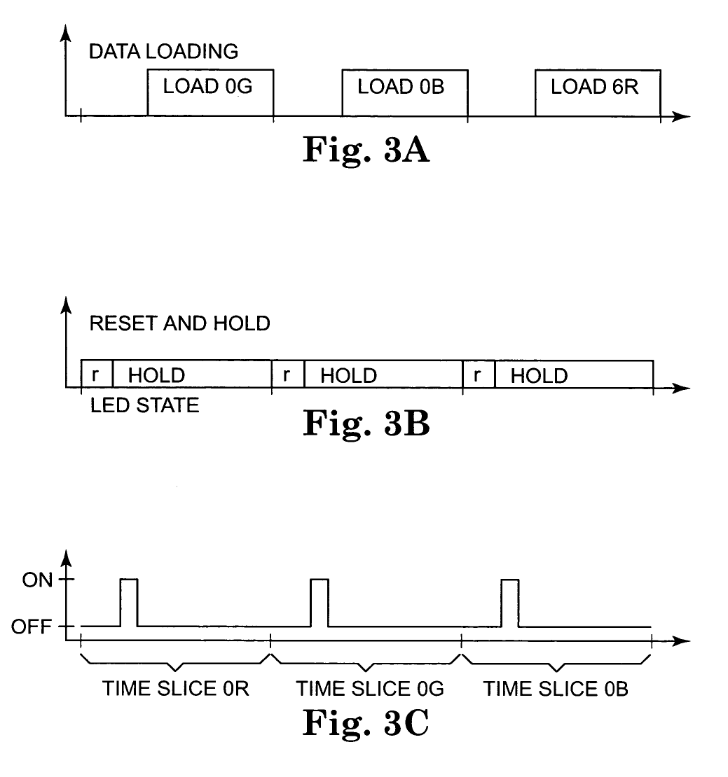

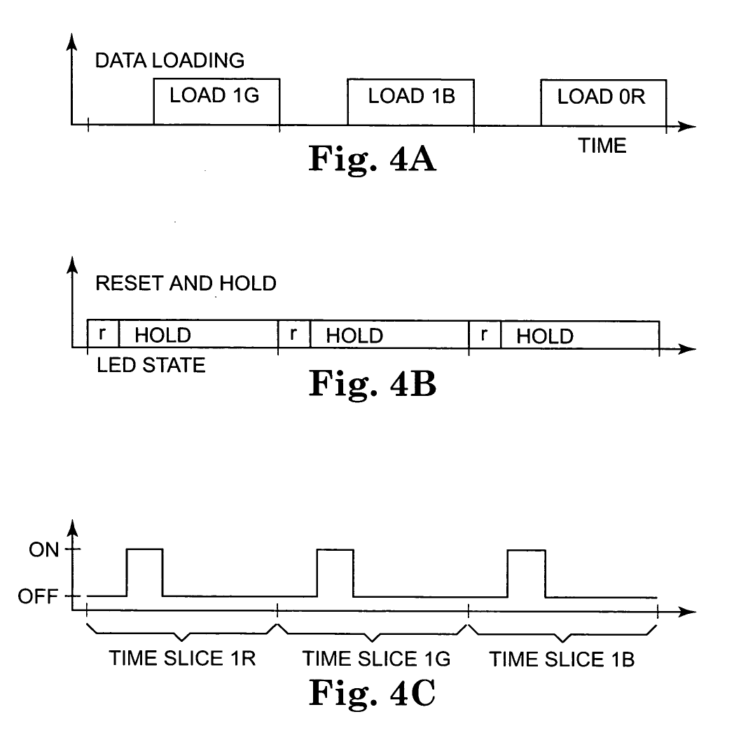

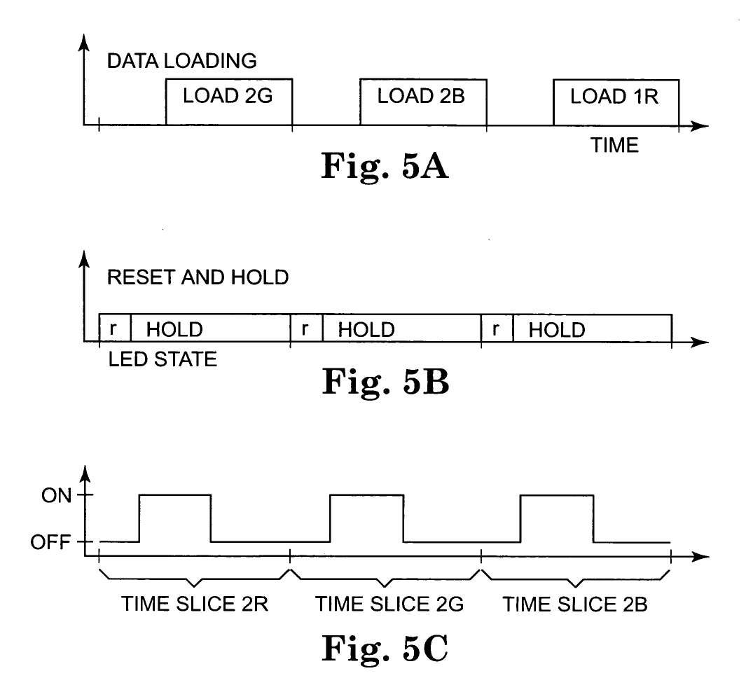

FIGS. 3-5 depict timing diagrams for the 3 least significant bit planes, including bit plane 0, 1, and 2. The least significant bit planes are not divided up temporally into time slices; therefore bit plane 0 can be referred to as time slice 0 and vice versa. For each bit plane depicted, the timing diagram illustrates (A) data loading to the DMD, (B) reset (r) and hold signals, and (C) LED operation. FIGS. 3A, 4A, and 5A depict timing for data loading for bit planes 0, 1, and 2, respectively. FIGS. 3B, 4B, and 5B depict the application of reset (r) and hold signals for bit planes 0, 1, and 2, respectively. FIGS. 3C, 4C, and 5C depict the operating of the LEDS for bit planes 0, 1, and 2, respectively.

For each time slice (or bit plane), data is loaded in the prior time slice. For example, referring to FIG. 3A, data for time slice 0G (bit 0 for green) is loaded while the time slice 0R (bit 0 for red) is being manifested on the light modulator 16. The least significant bit time slices each have a long enough time duration to allow the pixel data for the entire pixel array to be transferred from image processing unit 12 to spatial light modulator 16 during each of the least significant bit time slice periods.

Each time slice generally contains a reset sequence starting at the beginning of the time slice and a hold sequence ending at the end of the time slice. At the start of a time slice, the image processing unit sends a reset pulse (r) to the pixel elements. This allows the pixel elements to assume a position consistent with the data received during the previous time slice. For example, referring to FIGS. 3A-3C, during the reset pulse (r) received during time slice 0G, the pixel elements align themselves pursuant to the data (0G) received and loaded during time slice 0R.

Once the pixel elements have had time to reset, a hold signal is applied. This hold signal places the pixel elements into their proper ON or OFF state for the time slice (according to bit plane data). The hold signal is applied until the end of time slice.

The LED light source is off at the beginning of each time slice. The LED lights source turns on at the beginning of or during the hold signal. The LED light source turns off at the end of or during the hold signal. Thus, the LED light source generates a pulse that is temporally contained within the duration of the hold signal.

FIGS. 3C, 4C, and 5C depict pulse width modulation of the LED light source to define bit planes 0, 1, and 2 respectively. FIGS. 3-5 depict a single LED pulse defining the contribution of each bit plane or time slice, but the pulses can just as easily be further subdivided within each time slice. The LED light source may be able to define pulse widths as narrow as approximately 1 microsecond. In this way, what is depicted in the figures as a single pulse, could alternatively be multiple pulses.

In one embodiment, image processing unit 12 is also configured to analyze the incoming video signal and in response to generate image characteristic information indicative of the incoming video signal. Based upon image characteristic information, the image processing unit sends second control signals that define an illumination characteristic of light received by the spatial light modulator 16 from solid state light source 14 for each bit plane. In one embodiment, the illumination characteristic of light defines the primary color and/or the average intensity of light received by the light modulator 16 during the bit plane time period defined by each bit plane.

The image processing unit 12 analyzes the incoming frames based on the characteristics of the frames in order to define the image characteristic information indicative of the video signal. In one embodiment, the image characteristic information is indicative of an illumination intensity characteristic of at least one of the incoming frames. In one case, the illumination intensity characteristic is an average luminance of light during a frame period, which can be measured in a variety of ways.

In one embodiment, image processing unit 12 analyzes incoming image frames based on a multi-frame aspect, and in another, on a frame-by-frame aspect. Alternatively, image processing unit 12 receives a select signal from the user of the projector indicative of an operating preference and produces image characteristic information from this user selection. For example, in one case the user increases brightness at the expense of color gamut in order to achieve a desired output. In still other embodiments, image characteristic information is produced from a combination of analysis of the incoming frames based on the characteristics and upon a user selection.

Once image processing unit 12 generates the image characteristic information, either from analyzing the incoming frames, from user selection, or a combination thereof, image processing unit 12 then generates bit plane control signals for the spatial light modulator 12 and the solid state light source 14 based upon the image characteristic information. The bit plane control signals include first control signals imparted to the spatial light modulator 16 and second control signals imparted to the solid state light source. The first set of control signals define a plurality of bit planes to be manifested upon the spatial light modulator. For each bit plane, the first set of control signals defines which pixel elements are in an ON or OFF state during the bit plane as well as the bit plane duration. The second set of control signals define a primary color (spectral distribution) and average intensity of light received by the spatial light modulator for each bit plane as discussed by the following examples.

In a first example, the second set of control signals defines an average intensity of light received by the spatial light modulator during a frame period. In this example, the image characteristic information may be indicative of the brightness of scene to be displayed by system 10. The image processing unit may then adjust the average intensity or duty cycle of the solid state light source during each image frame or a sequence of image frames.

In a second example, the second set of control signals defines an average intensity of light received by spatial light modulator 16 within each bit plane. In this second example, the solid state light source is turned off during pixel element transitions and is modulated rapidly enough to only be on during each bit plane.

In a third example, the image processing unit 12 defines what primary colors are utilized during a frame period. For example, additional primary colors beyond red, green, and blue can be utilized. This may be important if a scene to be displayed is dominated by a particular color such as yellow, cyan, or white. In such a case, the signals define yellow, cyan, and/or white bit planes or time slices that may be interleaved with the RGB (red, green, and blue) bit planes.

In a fourth example, the image processing unit 12 defines a portion or fraction of the frame period duration to be allocated for each primary color. For a scene that is dominated by red, for instance, the combined duration of the red bit planes may utilize more than one third of the duration of the frame period.

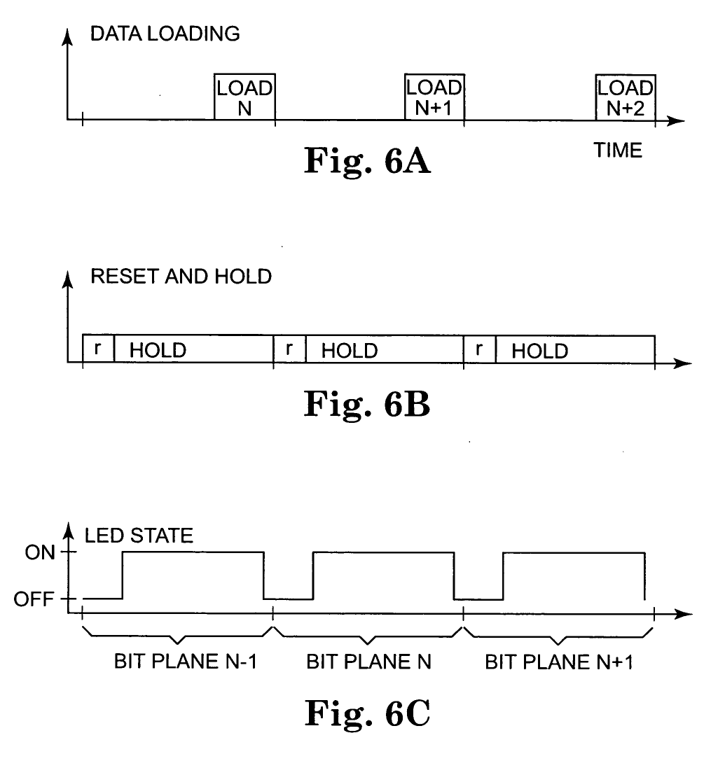

FIGS. 6A-6C are timing diagrams illustrating an exemplary optimized sequence for image display system 10. Image display system 10 utilizes the DMD array and the LED light source to optimize an operating sequence for each bit plane as follows: (1) The LED light source is initially OFF; (2) The bit plane data is loaded to the DMD prior to the bit plane time period; (3) The DMD array receives a reset signal at the start of the bit plane time period; (4) A HOLD signal is applied to the DMD until the end of the bit plane time period; (5) The LED light source is switched to the ON state at least once after HOLD signal is started and switched to the OFF state before the bit plane period is over.

Conventional DLP systems utilize a periodic color light source, such as a color wheel that modulates a light beam. The modulated light is cast upon a micro-mirror array of the DMD. The color wheel generates a complete sequence of color sub-frames during a frame period. With such a system, however, it is difficult to switch the mirrors fast enough to achieve a high bit depth. Also, contrast ratio losses occur due to light reflected during mirror transitions, and “spoke losses” of light occur during transitions between primary colors.

With the above-described optimized sequence, image display system 10 can ensure that the LED light source is not on when the micro-mirrors of the DMD array are in transition to or from the tilted state, thereby avoiding light leakage. Furthermore, the speed at which the LED light source can be controlled is utilized to enable high bit depths, controlled such that blanking periods do not reduce brightness, and increases contrast ratio.

In another embodiment, the bit planes are further interleaved such that the primary color being displayed is varied many times during a frame period up to the number of bit planes minus one. In this way, “rainbow effect” artifacts of sequential color are avoided where the primary colors are interleaved.

In one embodiment, image processing unit 12 is configured to analyze the incoming video signal to determine the incoming video frame rate and an original frame rate. In some instances, the video frame rate can be different than the original frame rate. In some cases, video images are initially recorded at an original frame rate that is conducive to capturing the images. Then, the recorded video images are later converted to a video frame rate that is conducive to displaying the images, such as on viewing surface 18.

For example, projector systems that are used as televisions and computer monitors are generally expected to receive incoming video signals having input video frame rates of 60 Hz, which is a typical standard progressive scan rate. The original frame for a typical standard film-based move rate, however, is 24 Hz. Thus, the original frame rate of 24 Hz must be converted to 60 Hz in such a projector system. A 3-2 pull-down system is typically utilized to convert from a 24 Hz original or source frame rate to a 60 Hz video frame rate. When displayed at the new video frame rate, visual artifacts (3-2 shuffle for instance) are sometimes created. Similarly, European television format is typically 50 Hz, and computer graphics formats that can vary between 45 to 75 Hz. Each of these can also require conversion between original frame rates and video frame rates also causing artifacts.

In one embodiment, the input video frame rate is determined by counting the period between vertical synchronization signals. In one case, the original frame rate may be determined by analyzing image data between adjacent frames and determining how the frame rate of the video signal has been altered. For example, consider an incoming video signal with a video frame rate of 60 Hz. If no motion is detected between alternating groups of 2 and 3 fields making up each frame of the signal, then the source was likely film shot at 24 frames per second. Then the solid state light source will generate complete sets of image frames at 24 Hz or a multiple of 24 Hz.

Once image processing unit 12 analyzes the incoming video signal and determines the original frame rate and video frame rate, an optimized frame rate and a corresponding optimized frame period are then selected based upon the original frame rate. Control unit 22 generates a sequence of bit plane time slices on spatial light modulator 16 during this optimized frame period. Control unit 22 further defines a sequence of primary color transitions for solid state light source 14. This sequence of primary color transitions illuminates the spatial light modulator 16 during the optimized frame period.

While in the above exemplary discussion, the optimized frame rate is based on the original frame rate, this does not have to be the case. In some embodiments, a different frame rate, such as an incoming frame rate or an increased frame rate relative to the incoming frame rate, is utilized to enhance certain image characteristics.

Resolution enhancement can be facilitated by increasing the frame rate relative to either the original frame rate and/or the incoming frame rate. In one embodiment, this is accomplished by defining image sub-frames that represent data frames that are displaced with respect to each other by sub-pixel amounts. Thus, “optimized frame rate” is tailored in each embodiment based on the desired features of the projection system. Because the projector of the present invention enables more than 15 primary color transitions during each frame period, an optimized frame rate selection need not be limited by concerns of spoke losses or sequential artifacts.

In one embodiment more than 15 primary color transitions are generated during each optimized frame period. Unlike prior color-wheel type systems, solid state light source 14 can be controlled to generate more than 15 primary color transitions during each optimized frame period without producing spoke losses and similar visual artifacts. Yet, by generating more than 15 primary color transitions during each optimized frame period, image display system 10 can display high-quality images that are based on the original frame rate.

In some embodiments as many as 20, 40 or more primary color transitions can be generated during each optimized frame period in order to enhance the image quality. In some cases, the number of color transitions during each optimized frame period is at least equal to the bit depth. In other cases, the number of color transitions during each optimized frame period is approximately equal to the number of time slices within each frame period.

In one embodiment, once image processing unit 12 has determined the original frame rate of the incoming video signal, the optimized frame rate is selected such that it is equal to the original frame rate. In another case, the optimized frame rate is selected such that it is equal to an integer multiple of the original frame rate. In many embodiments, such selection will enhance the image quality.

In yet another embodiment, the optimized frame rate is equal to the incoming frame rate (a frame rate inherent in the video signal reaching image processing unit 12) or an integer multiple of the incoming frame rate. Optimizing the frame rate may include locking on to the incoming signal based on an analysis of the incoming video signal frame rate.

Although specific embodiments have been illustrated and described herein, it will be appreciated by those of ordinary skill in the art that a variety of alternate and/or equivalent implementations can be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is Claimed is:

1. An image processing unit comprising:
a processor unit configured to analyze an incoming video signal and to select an optimized frame period in response;
a control unit configured to generate a first control signal that manifests a sequence of bit plane time slices on a spatial light modulator during the optimized frame period and further configured to generate a second control signal that defines a sequence of more than 15 primary color transitions for a solid state light source that illuminates the spatial light modulator during the optimized frame period.

2. The image processing unit of claim 1, wherein the second control signal further defines a sequence of more than 20 primary color transitions for the solid state light source that illuminates the spatial light modulator during the optimized frame period.

3. The image processing unit of claim 1, wherein the second control signal further defines a sequence of more than 30 primary color transitions for the solid state light source that illuminates the spatial light modulator during the optimized frame period.

4. The image processing unit of claim 1, wherein the number of time slices in the sequence of bit plane time slices on the spatial light modulator defines a bit depth, and wherein the number primary color transitions for the solid state light source that illuminates the spatial light modulator during the optimized frame period is at least equal to bit depth.

5. The image processing unit of claim 1, wherein the number of time slices in the sequence of bit plane time slices on the spatial light modulator is approximately equal to the number primary color transitions for the solid state light source that illuminates the spatial light modulator during the optimized frame period.

6. The image processing unit of claim 1, wherein the processor unit is further configured to determine an original frame rate and wherein the processor unit selects the optimized frame rate to be equal to the original frame rate.

7. The image processing unit of claim 1, wherein the processor unit is further configured to determine an original frame rate and wherein the processor unit selects the optimized frame rate to be equal to an integer multiple of the original frame rate.

8. The image processing unit of claim 1, wherein the solid state light source emits a sequence of pulses, each pulse contained within one bit plane time slice.

9. An image processing unit comprising:
processing means for analyzing an incoming video signal and for generating image frames having an optimized frame period; and
control means for converting each image frame into bit planes and for imparting a sequence of bit plane control signals to a spatial light modulator and for generating a sequence of control signals to a solid state light source that each define a light pulse generated by the solid state light source;
wherein each bit plane control signal defines states of each of an array of pixel elements on the spatial light modulator during a time slice time period;
wherein each light pulse has a spectral distribution that defines one of a set of primary colors; and
wherein the light pulses generate the set of primary colors at least 5 times during the optimized frame period.

10. The image processing unit of claim 9, wherein the light pulses generate the set of primary colors at least 10 times during the optimized frame period.

11. The image processing unit of claim 9, wherein the light pulses generate the set of primary colors at least 15 times during the optimized frame period.

12. The image processing unit of claim 9, wherein each light pulse is contained within a time slice time period

13. An image processing unit comprising:
a processor unit configured to analyze an incoming video signal and to generate image frames having an optimized frame period; and
a control unit configured to convert each image frame into bit plane control signals that each define states of each of an array of pixel elements of a spatial light modulator and further configured to generate at least 5 sequences of illumination control signals that each define a sequence of primary colors of light received by the spatial light modulator from a solid state light source during the optimized frame period.

14. The image processing unit of claim 13, wherein the control unit further defines a sequence of more than 20 primary color transitions for the solid state light source that illuminates the spatial light modulator during the optimized frame period.

15. The image processing unit of claim 13, wherein the control unit further defines a sequence of more than 30 primary color transitions for the solid state light source that illuminates the spatial light modulator during the optimized frame period.

16. An image processing unit comprising:
a control unit configured to generate a first control signal imparted to a spatial light modulator having an array of pixel elements and a second control signal imparted to a solid state light source;
wherein the first control signal defines a sequence of states of each of the array of pixel elements during each of a sequence of time slices; and
wherein the second control signal defines state changes for the solid state light source within each of at least 15 time slices of the sequence of time slices within an image frame period.

17. The image processing unit of claim 16, wherein the second control signal defines state changes for the solid state light source within each of at least 25 time slices of the sequence of time slices.

18. The image processing unit of claim 16, wherein the second control signal defines state changes for the solid state light source within each of at least 35 time slices of the sequence of time slices.

19. The image processing unit of claim 16, wherein the control unit is configured to convert image frame data into bit planes and wherein each bit plane defines one or more of the sequences of states of the array of pixel elements.

20. The image processing unit of claim 16, further comprising a processor unit configured to analyze an incoming video signal and to select the image frame period in response.

21. The image processing unit of claim 20, wherein the processor unit is further configured to determine an original frame rate and wherein the processor unit selects the image frame period based on the original frame rate.

22. A method for processing an image comprising:
analyzing an incoming video signal;
selecting an optimized frame period in response to the incoming video signal;
generating a first control signal that manifests a sequence of bit plane time slices on a spatial light modulator during the optimized frame period;
generating a second control signal that defines a sequence of more than 15 primary color transitions for a solid state light source that illuminates the spatial light modulator during the optimized frame period.

23. The method of claim 22 further including defining a sequence of more than 20 primary color transitions for the solid state light source that illuminates the spatial light modulator during the optimized frame period.

24. The method of claim 22 further including defining a sequence of more than 30 primary color transitions for the solid state light source that illuminates the spatial light modulator during the optimized frame period.

25. The method of claim 22 further including defining a bit depth based on the number of time slices in the sequence of bit plane time slices on the spatial light modulator defines, and wherein the number primary color transitions for the solid state light source that illuminates the spatial light modulator during the optimized frame period is at least equal to bit depth.

26. The method of claim 22, wherein the number of time slices in the sequence of bit plane time slices on the spatial light modulator is approximately equal to the number primary color transitions for the solid state light source that illuminates the spatial light modulator during the optimized frame period.

27. The method of claim 22 further including determining an original frame rate and selecting the optimized frame rate to be equal to the original frame rate.

28. The method of claim 22 further including determining an original frame rate and selecting the optimized frame rate to be equal to an integer multiple of the original frame rate.

29. The method of claim 22, wherein the solid state light source emits a sequence of pulses, each pulse contained within one bit plane time slice.
